(19) United States
(12) Patent Application Publication
(10) Pub. No.: US 2008/0224834 A1
(43) Pub. Date: Sep. 18, 2008

(54) Communication System For Information Of Home-Use Electrical Devices

(75) Inventors: Naohisa Oosaka, Osaka (JP); Hironori Kanda, Osaka (JP)

Correspondence Address: DLA PIPER US LLP, P. O. BOX 9271, RESTON, VA, 20195, US

(73) Assignees: KABUSHIKI KAISHA TOSHIBA, Minato-ku, Tokyo (JP); TOSHIBA CONSUMER MARKETING CORPORATION, Chiyoda-ku, Tokyo (JP); TOSHIBA HA PRODUCTS CO., LTD., Ibaraki-shi, Osaka (JP)

(21) Appl. No.: 11/569,865

(22) PCT Filed: May 27, 2005
(86) PCT No.: PCT/JP2005/009799

§ 371 Date: Nov. 30, 2006

(30) Foreign Application Priority Data
May 31, 2004 (JP) 2004-162223

(51) Int. Cl. G08B 1/08

(52) U.S. Cl. 340/286.02

(57) ABSTRACT

A home-use electrical device information communication system comprises a home-use electrical device (150) that can be connected wirelessly or by wire to a home network (30) to send a notification into the home network (30) at the occurrence of a change in the status; a home server (120) that resides within the home-use electrical device and home network and receives information automatically notified from the home-use electrical device to transmit it to the exterior via the Internet; and an information server (300) that is connected to the Internet and receives the notification from the home server. The home server (120) holds a single application for receiving notifications from the home-use electrical device.

### TECHNICAL FIELD

The present invention relates to a communication system for information of home-use electrical devices.

### BACKGROUND TECHNOLOGY

A communication system for information of home-use electrical devices generally includes a single or a plurality of home-use electrical devices capable of connecting themselves to the Internet by wireless or wire and notifying a state change, if occurs, to a home network, a home server existing in the home network together with the home-use electrical devices, to receive information automatically notified from each one of the home-use electrical devices, and transmitting the information to a specific information server through the Internet, and the information server connected to the Internet and receiving the notification from the home server. This system automatically notifies an abnormality of a connected device to the information server. To achieve the automatic notification of an abnormality of a connected device, the related art beforehand specifies devices that can receive services. Due to this, adding a new kind of device to the home network requires preparing application for the home server separately from that for an existing connection, or updating application of the home server by a customer or by a service provider, if the kind of device to be added employs a different abnormality notifying function.

Namely, to newly connect a new home-use electrical device to the home network, the related art must develop an abnormality notification device and software for covering the device. Such development is problematic because it involves a heavy burden.

### DISCLOSURE OF INVENTION

In consideration of the technical problem of the related art, an object of the present: invention is to provide a communication system for information of home-use electrical devices capable of covering future new kinds of devices and involving no burden in developing a network communication function between a home-use electrical device and a home server.

Another object of the present invention is to provide a communication system for information of home-use electrical devices capable of providing a versatile information notifying function for each home-use electrical device and individually processing notification information sent from each home-use electrical device.

A communication system for information of home-use electrical devices according to an invention of claim 1 includes a home-use electrical device connectable to a global network by wireless or wire, to notify a state change, if occurs, to a home network, a home server existing in the home network together with the home-use electrical device, to receive information automatically notified from the home-use electrical device and transmit the information through the global network, and an information server connected to the global network, to receive the notification from the home server, and wherein the home server is configured to hold a single application capable to receive the notification from any one of the home-use electrical devices.

According to an invention of claim 2, the home server in the communication system for information on home-use electrical devices of claim 1 executes a different process depending on the contents of the notification from each home-use electrical device and provides an output corresponding to the contents of the notification.

According to an invention of claim 3, in the communication system for information of home-use electrical devices of claim 1 or 2, the information server is configured to refer to a database according to the notification from the home server and returns actual contents of the notification to the home server; the home server is configured to broadcast to the home network a display request for the actual contents received from the information server; and an electronic device that is connected to the home network and can serve as a display is configured to receive the broadcast actual contents and display the same.

According to the present invention mentioned above, each home-use electrical device sends a notification, a home server that receives the notification executes a process corresponding to the notification and sends the notification to an information server through the Internet. The information server retrieves notification contents from a database and returns the retrieved contents to the home server. The home server receives the retrieved contents and makes a display existing in the home network display the received contents.

### BRIEF DESCRIPTION OF DRAWINGS

FIG. 1 is a block diagram showing a communication system for information of home-use electric devices according to an embodiment of the present invention.

FIG. 2 is a block diagram showing a functional configuration of a home server according to the above-mentioned embodiment.

FIG. 3 is a block diagram showing a functional configuration of a home-use electrical device according to the above-mentioned embodiment.

FIG. 4 is a block diagram showing a functional configuration of an ASP server according to the above-mentioned embodiment.

FIG. 5 is a sequence diagram showing a member registration process according to the above-mentioned embodiment.

FIG. 6 is a sequence diagram showing a registration process of a new home-use electrical device according to the above-mentioned embodiment.

FIG. 7 is a sequence diagram showing a log accumulation process and a state change display process of a home-use electrical device group according to the above-mentioned embodiment.

FIG. 8 is a list of logs of a home-use electrical device group according to the above-mentioned embodiment.

FIG. 9 is a sequence diagram 1 showing a process of remote-controlling a home-use electrical device with an operation terminal according to the above-mentioned embodiment.

FIG. 10 is a sequence diagram 2 showing the process of remote-controlling a home-use electrical device with an operation terminal according to the above-mentioned embodiment.

FIG. 11 is a sequence diagram showing a process of displaying a fault occurring in a home-use electrical device with LEDs and an operation terminal according to the above-mentioned embodiment.

FIG. 12 is a sequence diagram 1 showing a process of confirming a fault in a home-use electrical device from an operation terminal according to the above-mentioned embodiment.

FIG. 13 is a sequence diagram 2 showing the process of confirming a fault in a home-use electrical device from an operation terminal according to the above-mentioned embodiment.

### BEST MODE OF IMPLEMENTATION

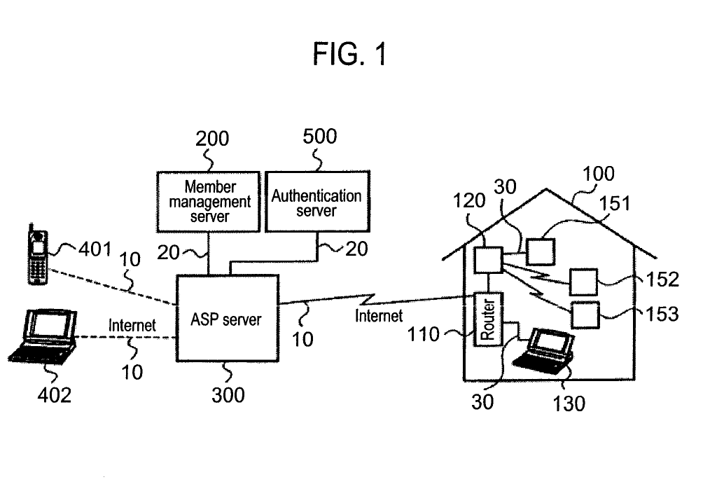

An embodiment of the present invention will be explained in detail with reference to the drawings. FIG. 1 shows a configuration of a communication system for information of home-use electrical devices according to an embodiment of the present invention. The communication system for information of home-use electrical devices of this embodiment includes a router 110, a home server 120, and various kinds of networked home-use electrical devices 151 to 153 arranged in a customer's home 100, an ASP server 300 serving as a home-use electrical device information server arranged in the Internet that is a global network, a member management server 200 serving as a customer information management server, and an authentication server 500 to execute a member authentication service. The servers 200 and 500 are connected through a dedicated local network 20 to the ASP server 300. To the ASP server 300, a portable terminal 401 such as a cellular phone or a PDA and a PC 402 are externally connected through the Internet 10. According to this embodiment, the local network is separated from the global network such as the Internet to which unspecified people are connectable and may be a private communication circuit or a VPN to which a person having no access right is not allowed to physically connect. The member management server 200 and the authentication server 500 may be made of a single computer system to execute member information management and an authentication process with respective software.

In the customer's home 100, there are the router 110 to achieve connection to the Internet 10 and the home server 120 to manage a home network 30. The home server 120 is connected to the networked home-use electrical devices 151 to 153 through the home network 30 that is wired and/or wireless. The home network 30 may be any one of or a plurality of a Bluetooth (registered trade name) network, a power-line network, an Ethernet (registered trade name), and a wireless network.

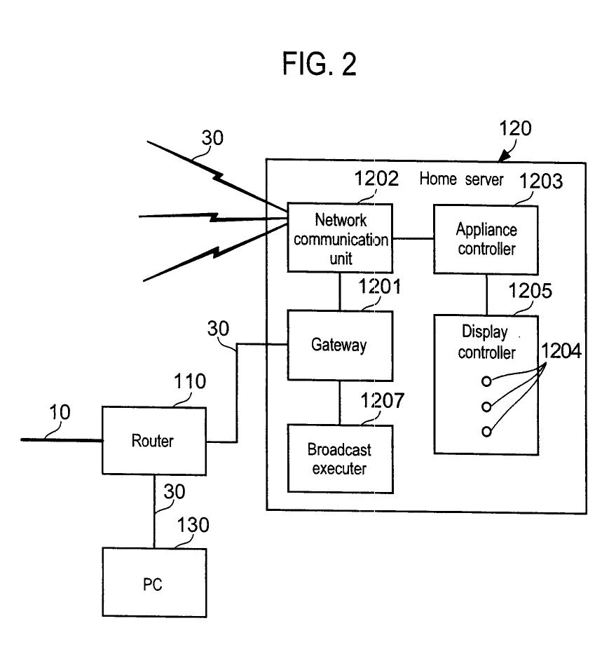

The home server 120 has a functional configuration shown in FIG. 2 and includes a gateway 1201, a network communication unit 1202 to conduct network communication with the home-use electrical devices 150 connected to the home network 30, a device controller 1203 to accumulate monitor and control data for the various home-use electrical devices, transmit an external command to each of the home-use electrical devices, and transfer a response from each of the home-use electrical devices, a display controller 1205 to emit light when any one of the home-use electrical devices causes an event such as a fault or an abnormality with LEDs 1204 arranged on the server 120 in a specific manner corresponding to the kind of the event and restore a normal light emission state of the LEDs, and a broadcast executer 1207. The broadcast executer 1207 receives a state change such as an abnormality occurrence, a start/stop event, an operation state change, or the like occurring in any one of the home-use electrical devices 151 to 153 connected to the home network 30, broadcasts display information about the state change to an operation terminal 130 such as a computer, a digital television set, a dedicated home terminal, or the like having a display function and connected to the home network 30, and makes the terminal pop-up-display the information.

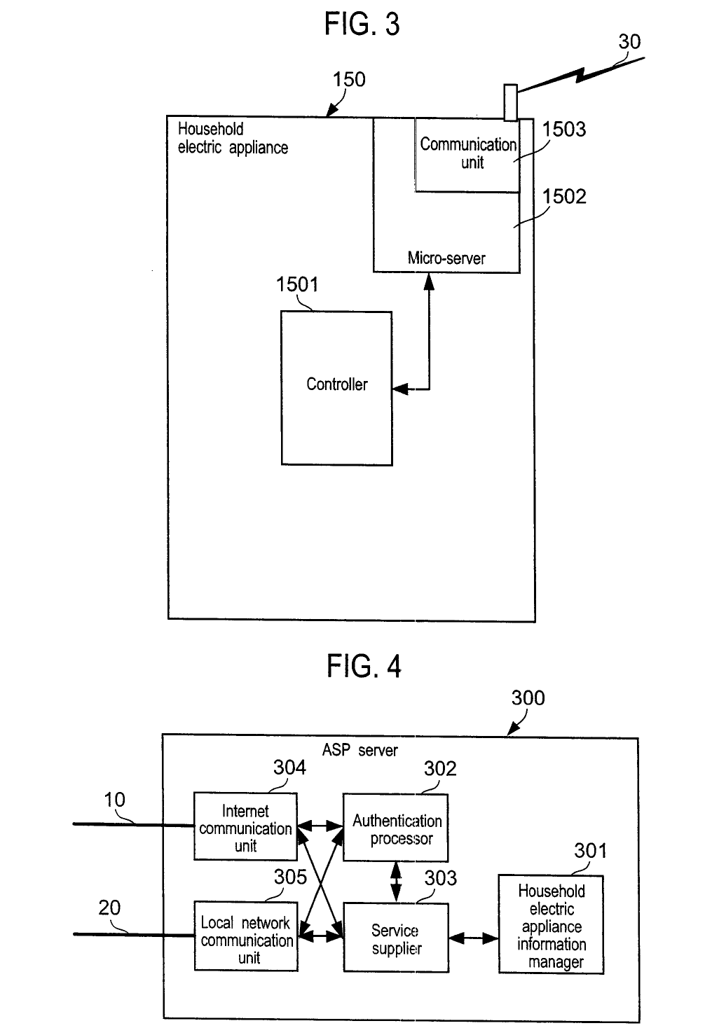

The networked home-use electrical devices 151 to 153 may include a washing machine, a refrigerator, an air conditioner, an electronic oven, and the like (represented with a reference mark 150). As shown in FIG. 3, the home-use electrical device 150 has a controller 1501 to control operation of the home-use electrical device, a micro-server 1502 to record and store data about a manufacturer, a product name, and work/fault history, and a communication unit 1503 to conduct network communication with the home server 120.

As shown in FIG. 4, the ASP server 300 manages screen information, control information, and information about the monitored and controlled home-use electrical devices that have diverse specifications depending on their manufacturers. The ASP server includes a home-use electrical device information manager 301 with a large-capacity storage unit, an authentication processor 302 to carry out a customer authentication process, a service supplier 303 to collect monitor and control information from home-use electrical devices of each customer and supply a monitor/control screen, an internet communication unit 304, and a local network communication unit 305 to communicate with the member management server 200 through the private local network 20. The member management server 200 is arranged as hardware that is physically separated from the ASP server 300, to collect and manage customer information. The home-use electrical device information manager 301 holds screen information, control information, and information about the monitored and controlled home-use electrical devices that have diverse specifications depending on their manufacturers, as well as information about new products to be additionally registered.

The member management server 200 is a server to collect and manage information on registered members who receive services from this system. This server accumulates personal information about members, information about the product names and model numbers of home-use electrical devices existing in the home server of each member, and member identification numbers.

The authentication server 500 carries out an authentication process for a person accessed to the ASP server 300, keeps member identification numbers and passwords for member confirmation, and determines through the authentication process whether or not the accessed person can log in.

Operation of the communication system for information of home-use electrical devices of the above-mentioned configuration will be explained.

[Member Registration]

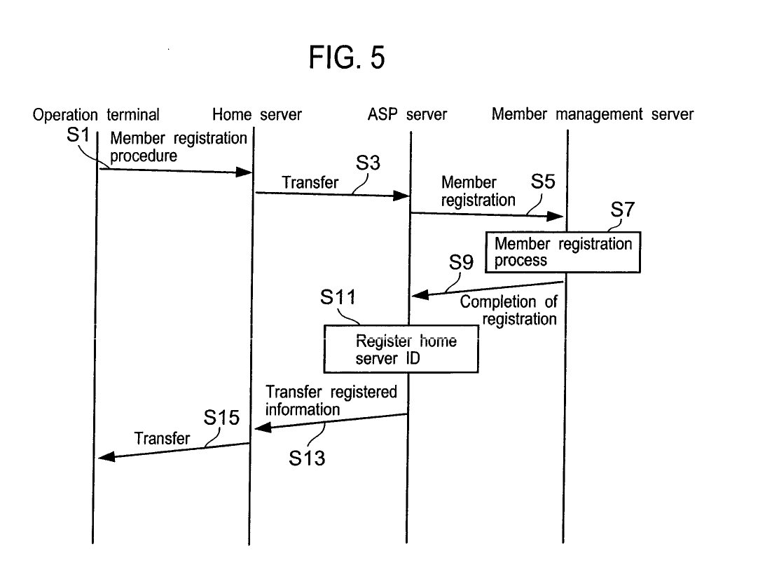

A person who uses the communication system for information of home-use electrical devices according to the embodiment must register as a member. As shown in FIG. 5, member registration is carried out by accessing the address of the ASP server 300 from the operation terminal 130 having a browser function, such as a home PC or a digital television set (steps S1 and S3). The access is connected through the router 110 to the ASP server 300 in the Internet 10. The personal information and identification number of the person are registered to the member management server 200. The identification number and password of the person are registered to the authentication server 500 (steps S5 to S9).

In this member registration procedure, the ASP server 300 registers unique identification information of the router 110 and home server 120 and identification information such as MAC addresses of the networked home-use electrical devices 151, 152, and 153 that are connected through the home network 30 to the home server 120 (step S11).

When the member registration is completed, the registered information is notified through the home server 120 to the access source, i.e., the operation terminal 130 (steps S13 and S15).

[New Registration of Home-Use Electrical Device]

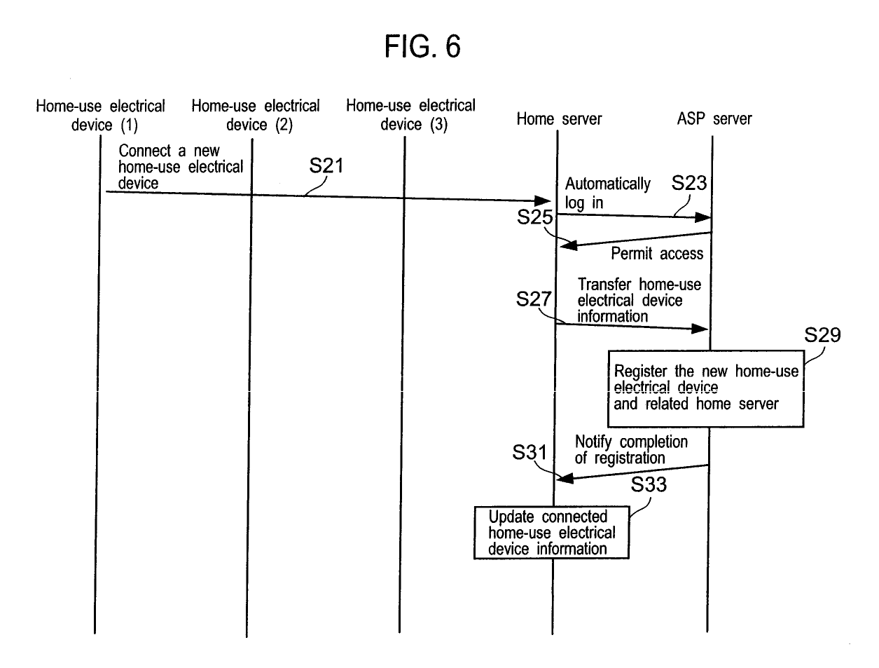

As shown in FIG. 6, when a newly purchased home-use electrical device such as a home-use electrical device (1) is connected to the home network 30, the home server 120 detects the same, receives information about the newly added home-use electrical device (step S21), automatically logs in the ASP server 300 with its own unique ID (steps S23 and S25), and transfers information such as the maker name, product name, type, and ID of the newly added home-use electrical device (1) (step S27). The ASP server 300 receives the information about the new device, relates the same to the ID of the home server 120, and registers it as home-use electrical device information (step S29). After the completion of registration, a completion notification and information about a service screen for remote-controlling the devices including the newly added home-use electrical device are returned to the home server 120, which updates a service screen (steps S31 and S33).

[Work History Accumulation]

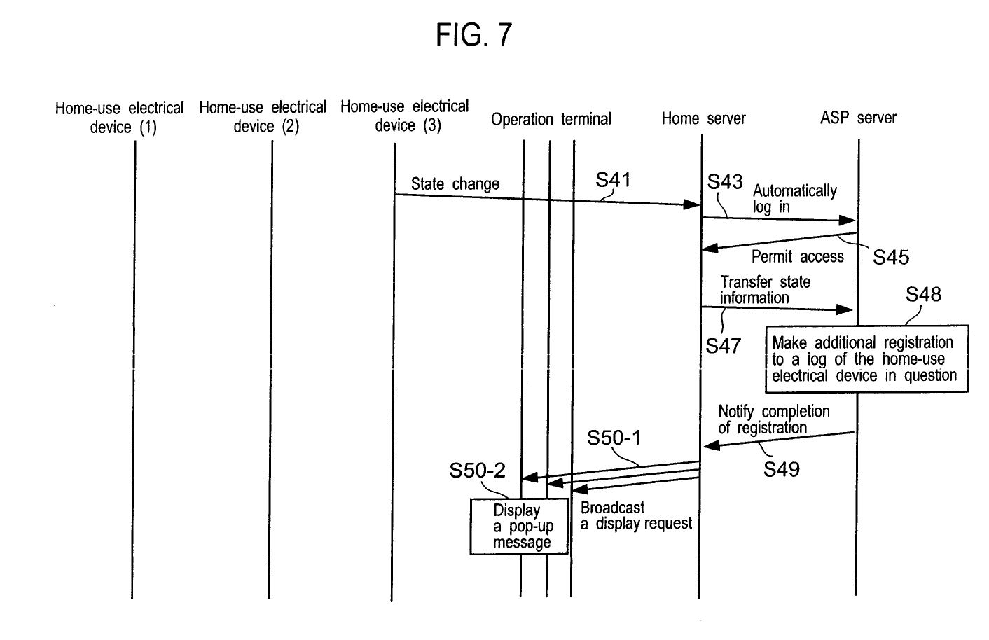

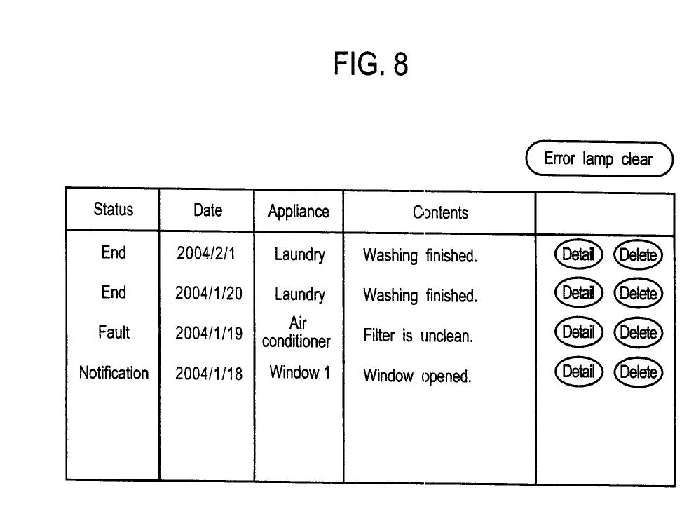

The ASP server 300 accumulates, for each home server, work history of the home-use electrical devices 151, 153, and 155 connected to the home server 120. In FIG. 7, if any one of the home-use electrical devices causes a state change (event) such as a power-on, power-off, washing completion, or filter contamination alarm, the home-use electrical device in question (in this example, the home-use electrical device (3)) transmits an event occurrence notification to the home server 120 (step S41). In response to the event occurrence notification, the home server 120 accesses and automatically logs in the ASP server 300 beforehand specified as a link destination (step S43). When connection is established, the event information of the home-use electrical device (3) is transferred to the ASP server (steps S45 and S47). The ASP server 300 relates the received event information to the ID of the home server 120 and registers the same as a log of the home-use electrical device (3) as shown in FIG. 8 (steps S48 and S49).

Receiving a registration completion notification from the ASP server 300, the home server 120 broadcasts a state information display request to the home network 30 (step S50-1). If any operation terminal 130, e.g., a digital television set operating within the home network 30 is ON, it displays a pop-up warning notification of “Fault occurred in the air conditioner on the second floor” or “Water is leaking from the washing machine,” or a state change notification of “Washing completed,” “The air conditioner on the second floor stopped,” “The electronic oven completed warming,” or the like (step S50-2).

The above-mentioned home server 120 carries out a proper process according to a state change notification from the home-use electrical device 150 as mentioned below. More precisely, it holds information related to the “maker name, model name, code, and process” of each device that can be referred to with a single application of the home server 120. The home server compares information sent from the home-use electrical device 150 with the information held in the home server and carries out a matched process.

The information held in the home server can be updated according to data downloaded from the ASP server 300.

[Mathematical 1]

Maker A, AIRCON_A, XXXX→Notification to server

Maker A, AIRCON_A, XYZW→Stop air conditioner

Maker A, AIRCON_B, XXXX→Notification to server

Maker B, LAUNDRY_A, YYYY→Stop washing

Maker B, AIRCON_C, XXXX→Notification to server

On the other hand, a database of the home-use electrical device information manager 301 in the ASP server 300 holds the following list of codes and messages:

[Mathematical 2]

Maker A, AIRCON_A, XXXX→Fuse has blown

Maker A, AIRCON_B, XXXX→Fuse has blown

Maker B, AIRCON_C, XXXX→Fuse has blown

If, for example, the home-use electrical device (3) of AIRCON_A of the maker A notifies the home server 120 of a state change information of “XXXX,” the home server 120 determines it as “Notification to server” according to the list of the mathematical 1 and notifies the state change to the ASP server 300.

The ASP server 300 receives the notification of “Maker A, AIRCON_A, XXXX,” refers to the database, determines that a fuse has blown, registers a log to the device, and returns a message of “Fuse has blown” to the home server 120. Receiving the message, the home server 120 uploads to the home network 30 a request for displaying a message of “Fuse has blown in Maker A, AIRCON_A” by broadcast. Any operation terminal 130 that is ON receives the message and pop-up-displays the same on the display of its own.

Instead of the home server 120 of each member, the ASP server 300 accumulates and manages logs of the networked home-use electrical devices as shown in FIG. 8. As a result, the home server 120 is relieved from excessive load.

If any one of the home-use electrical devices connected to the home network 30 causes an abnormality or an operational state change, information can be pop-up-displayed on any operation terminal 130 having a display function, to inform the contract member in a house in real time.

[Access from Operation Terminal]

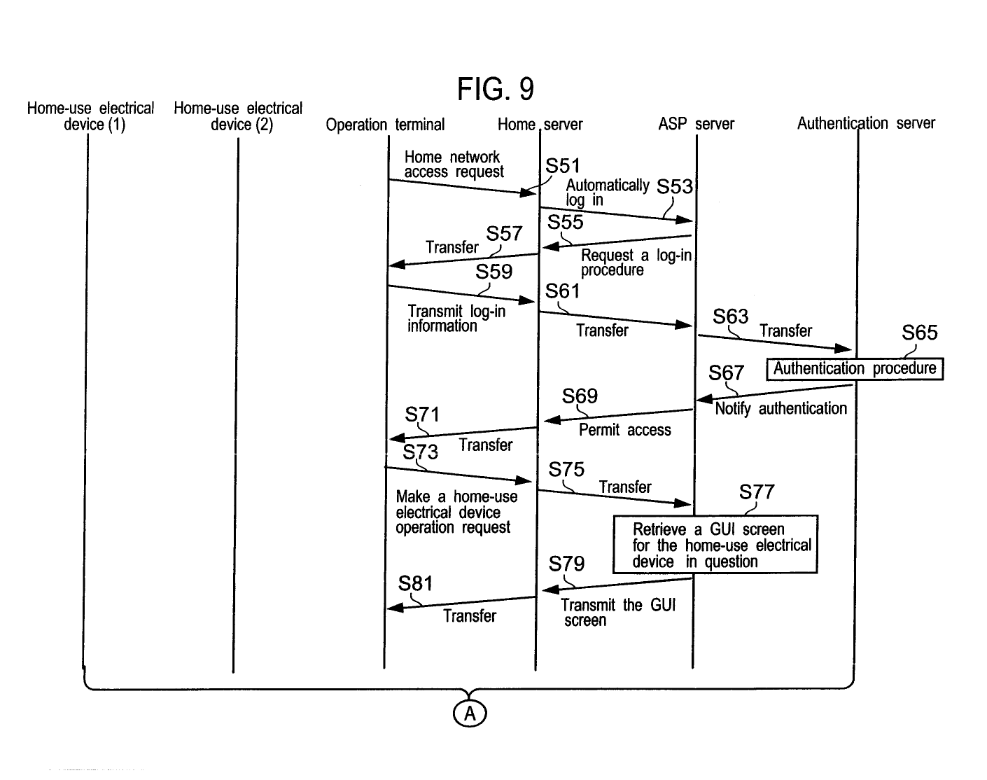

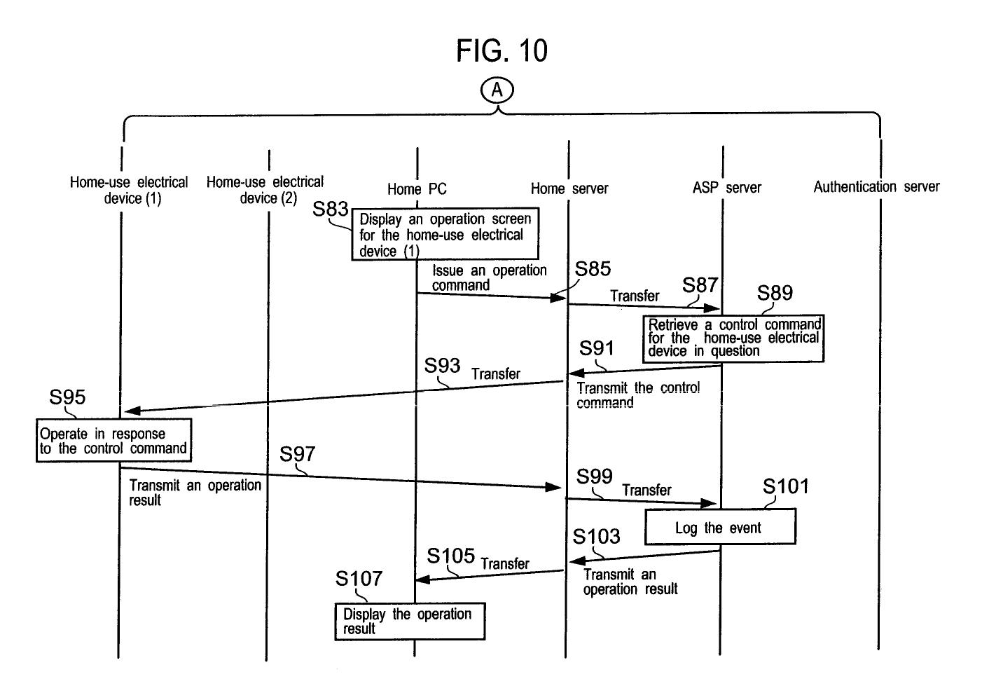

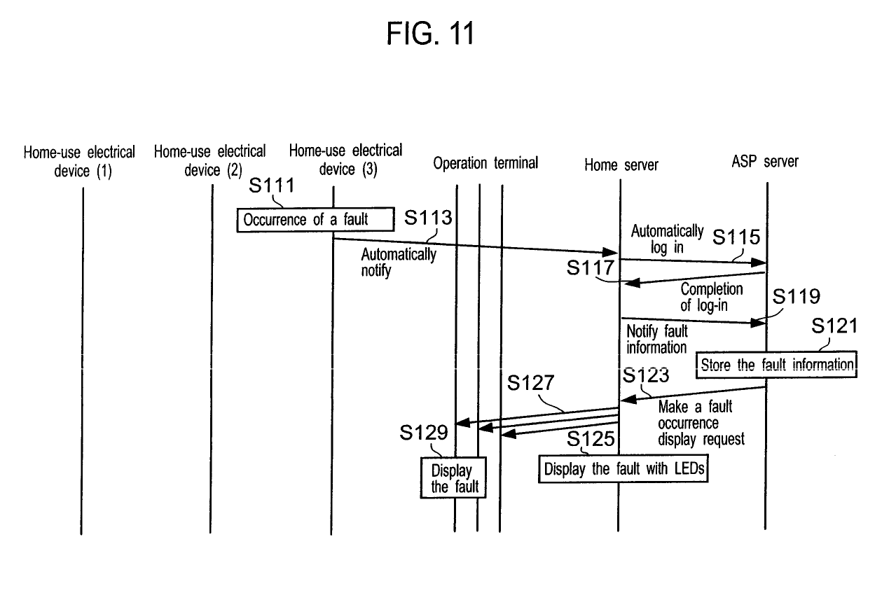

The member can use the operation terminal 130 such as a home PC or a digital television set having a browser function, to operate the home-use electrical devices connected to the home network 30. As shown in FIGS. 9 and 10, the member connects the operation terminal 130 to the router 110 and accesses the home server 120 (step S51). In response to an access request, the home server 120 accesses the linked ASP server 300 through the Internet 10 (step S53). The ASP server 300 requests a log-in procedure (steps S55 and S57), and the member enters an ID and a password with the operation terminal 130 to achieve the log-in procedure (step S59). The home server 120 transfers the log-in information to the ASP server 300 (step S61). The ASP server 300 communicates with the authentication server 500 through the local network 20 and executes an authentication procedure (steps S63 and S65). If the authentication procedure is successful, the ASP server 300 transmits an access permission for the operation terminal 130 and provides a service screen to allow the operation terminal to access an optional home-use electrical device connected to the home network 30 (steps S67 to S71).

Then, the member transmits from the operation terminal an operation request by specifying a home-use electrical device (step S73). The operation request is transmitted through the home server 120 to the linked ASP server 300 (step S75). The ASP server 300 retrieves a registered service screen for the home-use electrical device (in this example, home-use electrical device (1)) and transmits the service screen to the operation terminal 130 through the home server 120, so that the operation screen of the home-use electrical device is displayed (steps S77 to S83).

On the service screen displayed on the operation terminal 130, the member carries out, for example, a power-on, power-off, or temperature setting operation (step S85). The operation command is transferred from the home server 120 to the ASP server 300 through the Internet (step S87). From there, a corresponding operation signal is issued (steps S89 and S91) and is transferred through the home server 120 to the corresponding home-use electrical device (1) (step S93), to execute the operation (step S95). An operation result is returned from the home-use electrical device (1) to the home server 120 (step S97), which transfers the same to the ASP server 300 (step S99). The ASP server 300 retrieves a corresponding control result screen and returns the same through the home server 120 to the operation terminal 130 (steps S103 and S105). Receiving the control result screen information, the operation terminal 130 displays the same to allow the member to confirm the operation result (step S107).

In this way, the operation events of home-use electrical devices can centrally be collected, logged, and managed member by member by the ASP server 300, to reduce load on the home server 120.

[Fault Occurrence]

If a certain home-use electrical device, for example, the home-use electrical device (3) causes a fault, the home-use electrical device (3) transmits a fault notification to the home server 120 (steps S111 and S113). Receiving the fault notification, the home server 120 automatically logs in the ASP server 300 and notifies the fault information (steps S115 to S119). Receiving the fault information, the ASP server 300 relates the fault information of the home-use electrical device to the ID of the home server and registers the related data (step S121). The ASP server 300 transmits a fault information reception acknowledgement and a fault occurrence display command to the home server 120, i.e., the access source (step S123). In response to the command, the home server 120 displays a fault occurrence with the LEDs 1204 by, for example, blinking a red LED (step S125). In addition, the home server 120 broadcasts a display request of the fault information received from the ASP server 300 to the home network 30 (step S127). If any operation terminal 130, for example, a digital television set is operating in the home network 30, the operation terminal pop-up-displays the received fault information to notify the member of the same in real time (step S129). If no operation terminal 130 is operating, the fault information is kept by the home server 120 and is broadcast at predetermined intervals or is resent when any operation terminal 130 is turned on, so that the fault information may be pop-up-displayed.

[Confirmation of Fault Information]

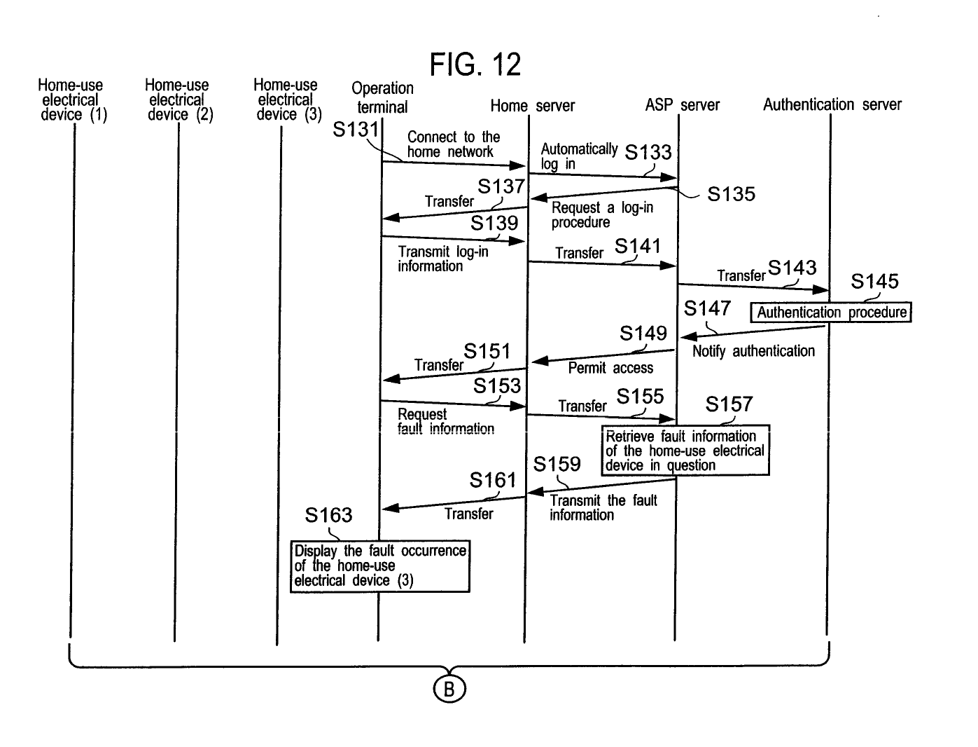

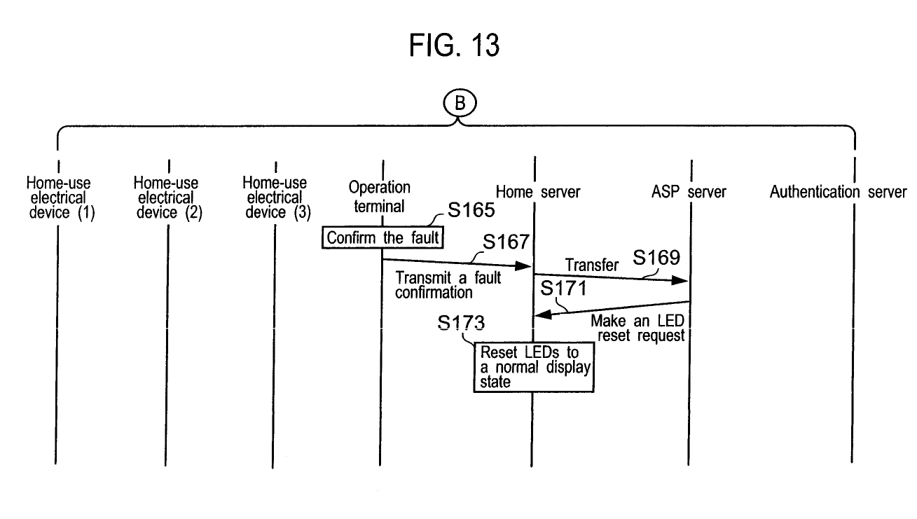

As shown in FIGS. 12 and 13, the member who sees the fault notification on the LEDs 1204 of the home server 120 or on the operation terminal 130 may want to confirm the fault. Then, the member uses the operation terminal 130 such as a home PC or a digital television set to access the home server 120 and makes a fault confirmation request (steps S131 to S153). The home server 120 transfers the fault information confirmation request to the ASP server 300 (step S155).

Receiving the fault information confirmation request, the ASP server 300 retrieves the fault information of the home-use electrical device related to the ID of the home server 120 and transmits the same to the access source, i.e., the operation terminal 130 (steps S157 to S161).

Receiving the fault information, the operation terminal 130 displays the fault information of the failed home-use electrical device (3) (step S163). The member confirms the fault information and conducts a confirmation operation by, for example, clicking an “Error lamp clear” button shown in FIG. 8 (step S165) to send a confirmation signal through the home server 120 to the ASP server 300 (steps S167 and S169). Receiving the fault information confirmation signal, the ASP server 300 transmits a fault display reset command for the LEDs 1204 to the home server 120, so that the fault displaying LEDs 1204 may restore a normal display state (for example, normally lighting-on a green LED) (steps S171 and S173).

The above-mentioned embodiment has explained functions of the system. The present invention realizes these functions by installing software in computer systems at various locations and by executing the software. Processing methods achieved by the software in the computer systems and the software itself are included in the technical scope of the present invention. The home server and ASP server that realize the above-mentioned functions are also included in the technical scope of the present invention.

### INDUSTRIAL APPLICABILITY

According to the present invention, an ASP server receives event information related to a fault or a state change of a certain home-use electrical device from a home server of a certain member. Then, the ASP server refers to a database, determines a fault state of the home-use electrical device corresponding to the event information, logs the event, and returns a fault state message to the home server. Receiving the message, the home server broadcasts, to a home network, a fault state message display request of the home-use electrical device. Any operation terminal that is ON receives the request and pop-up-displays the message on its own display. According to this system, the ASP server accumulates and manages, instead of the home server of each member, logs of networked home-use electrical devices of each member. This eliminates excessive load from each home server. If any one of the networked home-use electrical devices connected to the home network causes an abnormality or an operational state change, information related to the occurrence is pop-up-displayed on the display of an operation terminal having an information displaying function, so that the member can know the occurrence in real time.

1. A communication system for information of home-use electrical devices comprising a single or a plurality of home-use electrical devices connectable to a home network by wireless or wire, to notify a state change, if occurs, to the home network; a home server existing in the home network together with the home-use electrical devices, to receive information automatically notified from each home-use electrical device and transmit the information through a global network to the outside; and an information server connected to the global network, to receive the notification from the home server; and
the home server is configured to hold a single application to receive the notification from any one of the home-use electrical devices.

2. The communication system for information of home-use electrical devices as set forth in claim 1, wherein the home server executes a different process depending on the contents of the notification from the home-use electrical device and provides an output corresponding to the contents of the notification.

3. The communication system for information of home-use electrical devices as set forth in claim 1 or 2, wherein:
the information server refers to a database according to the notification from the home server and returns actual contents of the notification to the source home server;
the home server broadcasts to the home network a display request for the actual contents received from the information server; and
an electronic device that is connected to the home network and can serve as a display receives the broadcast actual contents and displays the same.
